(19) United States
(12) Patent Application Publication
(10) Pub. No.: US 2003/0192443 A1
(43) Pub. Date: Oct. 16, 2003

(54) Surface for a structural component of a printing machine

(75) Inventors: Ralph Klarmann, Augsburg (DE); Roland Dietrich, Stadtbergen (DE); Thomas Bock, Neusabeta (DE)

Correspondence Address: COHEN, PONTANI, LIEBERMAN & PAVANE, Suite 1210, 551 Fifth Avenue, New York, NY, 10176, US

(73) Assignee: MAN Roland Druckmaschinen AG

(21) Appl. No.: 10/347,986

(22) Filed: Jan. 21, 2003

(30) Foreign Application Priority Data
Jan. 26, 2002 (DE) 102 02 991.1

(51) Int. Cl. B41N 1/00

(52) U.S. Cl. 101/395

(57) ABSTRACT

The surface of a structural component of a printing machine from which ink or oil-based contamination can be cleaned easily has a hydrophilic character.

### BACKGROUND OF THE INVENTION

1. Field of the Invention

The invention is directed to a surface for a structural component of a printing machine which is exposed to wetting and contamination by printing ink.

2. Description of the Related Art

A considerable portion of the structural components in printing machines is exposed to contamination by inks. This contamination often causes high costs in servicing and repair which are reflected in maintenance costs that are sometimes high.

For automatic protection from soiling of all types, e.g., by ink or paper dust, DE 199 14 136 A1 proposes providing the surface of machine parts in printing machines with a microstructured coating with self-cleaning capability. It is proposed, for example, to provide a coating possessing hydrophobic and oleophobic properties. The purpose of the antiadhesive coatings is to achieve the lowest possible surface energy with respect to both dispersive and polar components. While commercially available coating systems meet this criterion to an adequate extent, results obtained for applications in the printing industry with its highly pasty contamination have been satisfactory at best.

It is the object of the invention to provide a surface for structural components of a printing machine which can easily be cleaned of ink and oil-based contamination.

### SUMMARY OF THE INVENTION

According to the invention, this object is met by the surface of the structural component having a hydrophilic character. Due to the hydrophilic character of the surface of the structural component, even severe contamination can be removed by a water-based cleaning liquid, preferably water. The cleaning liquid seeps under the dirt which can therefore be rinsed off easily.

### DETAILED DESCRIPTION OF THE PRESENTLY PREFERRED EMBODIMENTS

The invention will be described more fully in the following with reference to several embodiment examples. The surface is applied, for example, in washing systems for inking mechanisms and rubber blankets, collecting troughs, squeegee troughs, doctor blades or squeegees, protective devices, paper guiding rollers, splash plates, drip plates, moistening mechanisms, ink ducts, ink agitating mechanisms, funnels, deflectors in folding mechanisms, etc.

The hydrophilic surface of the structural component part can be formed of bulk materials, that is, materials from which the structural component is manufactured in solid form, or can be formed of a coating on the structural component. The following are suitable materials for these variants:

1. hydrophilic systems

2. systems with hydrophilically functionalized surfaces (e.g., groups of OH, COOH, COOM, NH₂, CFₓ, etc.)

3. crystalline, partially crystalline, amorphous or vitreous surfaces having a hydrophilic character

4. metallic surfaces having a hydrophilic character, e.g., chrome

5. oxidic systems with a hydrophilic character, e.g., TiO₂, CeO₂, ZrO₂, Y:ZrO₂

6. ceramic systems having a hydrophilic character, e.g., perovskites like SrTiO₃, BaTiO₃, etc.

7. hydropbilic polymers

8. hydrophilic copolymers

9. hydrophilically functionalized polymers (main chain, side chain)

10. polymer blends with hydrophilic characteristic

11. polymer composites with hydrophilic characteristic

12. host-guest systems having a hydrophilic character (polymer matrix with embedded molecules generating hydrophilicity).

Coatings can advantageously be carried out on structural components with the above-mentioned materials by means of the following methods (the numbers correspond to the preceding list of materials):

| Method | Coating material |
|---|---|
| chemical vapor deposition (CVD) | 1, 3, 4, 5, 6 |
| physical vapor deposition (PVD) | 1, 3, 4, 5, 6 |
| transport reactions | 1, 3, 4 |
| thermal evaporation | 1, 3, 4, 5, 6 |
| electron beam evaporation | 1, 3, 4, 5, 6 |
| plasma or flame spraying | 1, 3, 4, 5, 6 |
| sputtering | 1, 3, 4, 5, 6 |
| sol gel process | 1, 3, 5, 6 |
| immersion method | 1, 2, 3, 5, 6, 7, 8, 9, 10, 11, 12 |
| spray or paint method | 1, 2, 3, 5, 6, 7, 8, 9, 10, 11, 12 |
| electrodeposition method | 1, 4 |
| electrolytic or autocatalytic deposition | 1, 4 |
| laser ablation | 1, 3, 4, 5, 6 |
| plasma immersion ion implantation | 1, 3, 4, 5 |
| polymerization (radical, ionic, anionic, | |
| cationic) | 1, 2, 7, 8, 9, 10, 11, 12 |
| copolymerization | 1, 2, 7, 8, 9, 10, 11, 12 |
| polymer analogous reactions | 1, 2, 7, 8, 9, 10, 11, 12 |
| plasma polymerization | 1, 2, 7, 8, 9, 10, 11, 12 |

The hydrophilicity of the surface can also be created through structural (topographic) shaping or, in particular, can be positively influenced, e.g., through

special microstructures or nanostructures in the surface, i.e., in the range of 10⁻³ to 10⁻⁸ millimeters, which are produced, for example, after production of the coating, e.g., by means of laser radiation, or also during production of the coating by embossing methods and/or suitable deposition parameters,

defined surface roughness (for example, in the range of Rₐ≈0.2 to 50 μm), e.g., by defined deposition parameters or methods.

Hydrophilicity can be produced permanently by the systems mentioned above. But a time-dependent behavior can also be adjusted. In this case, hydrophilicity decreases over time. The surface can be chemically and/or physically treated in order to restore hydrophilicity, namely, by means of:

acids, alkalis and salts thereof, e.g., carboxylic acids, sulfonic acids, inorganic acids, mineral acids, etc., metal hydroxides and metal oxides

saline solutions, e.g., phosphates, citrates

tenside solutions (cationic, anionic, nonionic) and salts thereof

combinations of the above-mentioned systems with and without additives

irradiation with high-energy particles, e.g., UV radiation, electron radiation

activation by electrical fields, e.g., corona discharge.

Commercially obtainable systems like plate and roll cleaners such as Hydrocer-Clean, Ozasol, DICOwipe, DICOclean, Normakleen, etc., which work according to the surface activation mentioned above, are also available for activation. Often, only an apparent

We claim:

1. Surface for a structural component of a printing machine which is exposed to wetting and contamination by printing ink, wherein the surface of the structural component has a hydrophilic character.

2. Surface according to claim 1, wherein the surface is formed by a hydrophilic system.

3. Surface according to claim 1, wherein the surface is formed by a system with a hydrophilically functionalized surface.

4. Surface according to claim 1, wherein the surface is formed by one of a crystalline, partially crystalline, amorphous or vitreous surface having a hydrophilic character.

5. Surface according to claim 1, wherein the surface is formed by a metal having a hydrophilic character.

6. Surface according to claim 1, wherein the surface is formed by one of an oxidic and a ceramic system having a hydrophilic character.

7. Surface according to claim 1, wherein the surface is formed by one of a hydrophilic polymer, hydrophilic copolymer and hydrophilically functionalized polymer.

8. Surface according to claim 1, wherein the surface is formed by a polymer blend with hydrophilic character.

9. Surface according to claim 1, wherein the surface is formed by a polymer composite with hydrophilic character.

10. Surface according to claim 1, wherein the surface is formed by a host-guest system having a hydrophilic character.

11. Surface according to claim 1, wherein the surface is a coating generated by chemical vapor deposition (CVD).

12. Surface according to claim 1, wherein the surface is a coating generated by physical vapor deposition (PVD).

13. Surface according to claim 1, wherein the surface is a coating generated by transport reactions.

14. Surface according to claim 1, wherein the surface is a coating generated by thermal evaporation.

15. Surface according to claim 1, wherein the surface is a coating generated by electron beam evaporation.

16. Surface according to claim 1, wherein the surface is a coating generated by plasma or flame spraying.

17. Surface according to claim 1, wherein the surface is a coating generated by sputtering.

18. Surface according to claim 1, wherein the surface is a coating generated by a sol gel process.

19. Surface according to claim 1, wherein the surface is a coating generated by an immersion method.

20. Surface according to claim 1, wherein the surface is a coating generated by a spray or paint method.

21. Surface according to claim 1, wherein the surface is a coating generated by an electrodeposition method.

22. Surface according to claim 1, wherein the surface is a coating generated by electrolytic or autocatalytic deposition.

23. Surface according to claim 1, wherein the surface is a coating generated by laser ablation.

24. Surface according to claim 1, wherein the surface is a coating generated by plasma immersion ion implantation.

25. Surface according to claim 1, wherein the surface is a coating generated by polymerization (radical, ionic, anionic, cationic).

26. Surface according to claim 1, wherein the surface is a coating generated by copolymerization.

27. Surface according to claim 1, wherein the surface is a coating generated by polymer analogous reactions.

28. Surface according to claim 1, wherein the surface is a coating generated by plasma polymerization.

29. Surface according to claim 1, wherein the structural component is formed solidly of the material of the surface.

30. Surface according to claim 1, wherein the surface has a permanent hydrophilic character.

31. Surface according to claim 1, wherein the hydrophilicity of the surface can be refreshed by means of chemical and/or physical treatment.

32. Surface according to claim 1, wherein the surface has a special microstructure or nanostructure.

33. Surface according to claim 1, wherein the surface has special surface roughness.
